(19) United States
(12) Patent Application Publication
(10) Pub. No.: US 2012/0147884 A1
(43) Pub. Date: Jun. 14, 2012

(54) ROUTER APPARATUS USING POWER SAVING ROUTING INFORMATION AND ROUTING METHOD OF ROUTER APPARATUS

(75) Inventors: Seung Hyun YOON, Daejeon (KR); Ho Young SONG, Daejeon (KR)

(73) Assignee: Electronics and Telecommunications Research Institute, Daejeon (KR)

(21) Appl. No.: 13/316,065

(22) Filed: Dec. 9, 2011

(30) Foreign Application Priority Data
Dec. 13, 2010 (KR) 10-2010-0126823

(51) Int. Cl. H04L 12/56

(52) U.S. Cl. 370/389

(57) ABSTRACT

A router apparatus using power saving routing information and a routing method of the router apparatus are provided. The router apparatus using the power saving routing information may include an information generating unit to receive, from a neighboring router, state information about the neighboring router, and to generate a plurality of pieces of routing information based on the received state information, and a processor to select routing information corresponding to an operating request from the plurality of pieces of routing information, in relation to the operating request, and to use the selected routing information when transmitting traffic.

### CROSS-REFERENCE TO RELATED APPLICATION

This application claims the benefit of Korean Patent Application No. 10-2010-0126823, filed on Dec. 13, 2010, in the Korean Intellectual Property Office, the disclosure of which is incorporated herein by reference.

### BACKGROUND

1. Field of the Invention

The present invention relates to a router apparatus using power saving routing information and a routing method of the router apparatus, which may smoothly transmit traffic using a plurality of pieces of routing information about a neighboring router.

2. Description of the Related Art

Generally, a network is established by designing a communication device, a port, a line to be repeated in order to secure a capacity necessary at a peak time, and the established network is constantly operated without disruption. Accordingly, energy is consumed unnecessarily over time, excluding the peak time. In order to save energy, a temporary suspension of an operation of a part of communication equipment can be considered, for example, the communication device, the port, and the line, or to switch to a power saving mode, at a time when traffic is fairly moderate, excluding the peak time.

In a case of Internet routing, a router exchanges state information with a neighboring router through a routing protocol, and generates a routing table or a forwarding table based on the state information exchanged.

FIG. 1 is a diagram illustrating a routing method of a network according to a conventional art.

Referring to FIG. 1, a network may include a plurality of routers, for example, a first router, a second router, a third router, a fourth router, and a fifth router. Each of the plurality of routers may transmit state information to a neighboring router, and may receive state information about the neighboring router from the neighboring router. For example, the first router may transmit, to the third router, state information of the first router, for example, a state of a node or a link, and may receive state information of the third router from the third router. Also, the first router may generate a routing table as routing information, using the received state information of the third router, and may transmit traffic based on the generated routing table.

When the traffic transmission is disrupted due to an error in a predetermined path, a mode change of a router, or the like, such a change may be exchanged between routers, and the traffic may be bypassed and operated through another path that does not use communication equipment or a link in which the traffic transmission is disrupted.

However, a time ranging from a period of seconds to minutes may be required until a routing change in relation to the disruption is detected, a routing protocol is exchanged, and information about a disruptive state is transferred to the entire network and reflected in routing tables of all routers. Accordingly, the traffic may not be transmitted in a part of the network during a substantial period of time.

Accordingly, there is a desire for a routing technology that may adaptively deal with routing changes.

### SUMMARY

An aspect of the present invention enables smooth transmission of traffic irrespective of a state of a neighboring router, for example, being in a power saving state, by generating a plurality of pieces of routing information about a neighboring router, and using routing information corresponding to an operating request, among the plurality of pieces of routing information generated.

According to an aspect of the present invention, there is provided a router apparatus using power saving routing information, the router apparatus including an information generating unit to receive, from a neighboring router, state information about the neighboring router, and to generate a plurality of pieces of routing information based on the received state information, and a processor to select routing information corresponding to an operating request from the plurality of pieces of routing information, in relation to the operating request, and to use the selected routing information when transmitting traffic.

According to another aspect of the present invention, there is provided a routing method of a router apparatus using power saving routing information, the method including receiving, from a neighboring router, state information about the neighboring router, and generating a plurality of pieces of routing information based on the received state information, and selecting routing information corresponding to an operating request from the plurality of pieces of routing information, in relation to the operating request, and using the selected routing information when transmitting traffic.

### EFFECT OF THE INVENTION

According to embodiments of the present invention, traffic may be transmitted smoothly regardless of a state of a neighboring router, by generating a plurality of pieces of routing information about a neighboring router, and using routing information corresponding to an operating request, among the plurality of pieces of routing information generated.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a routing method of a network according to a conventional art;

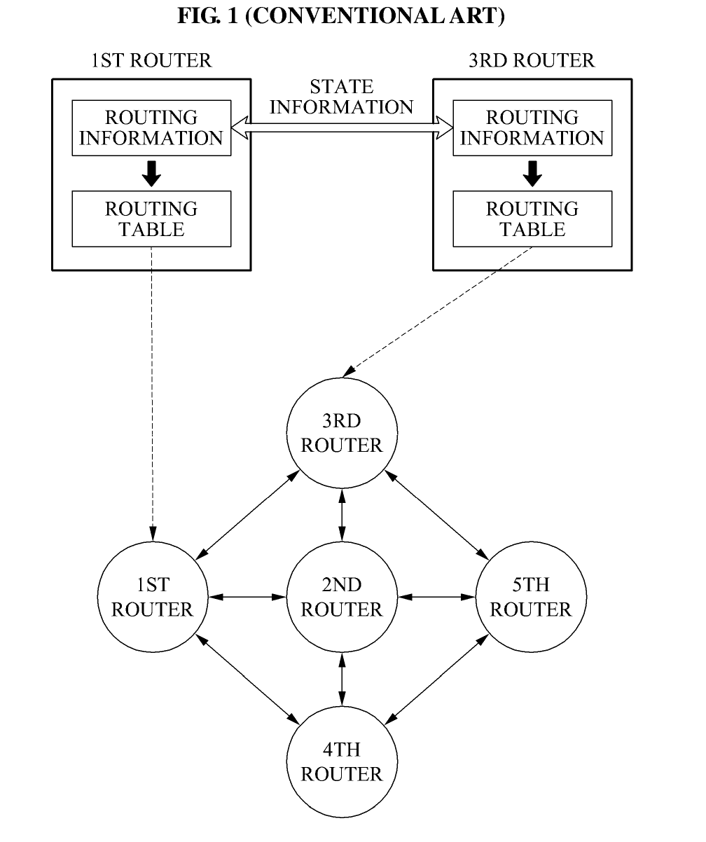

FIG. 2 is a diagram illustrating a configuration of a network including a router using power saving routing information according to an embodiment of the present invention;

FIG. 3 is a diagram illustrating a configuration of a router apparatus using power saving routing information according to an embodiment of the present invention; and

FIG. 4 is a flowchart illustrating a routing method of a router apparatus using power saving routing information according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A router apparatus using power saving routing information and a routing method of the router apparatus according to embodiments of the present invention will be hereinafter described in detail with reference to the accompanying drawings. Herein, a normal mode may refer to a mode for operating a router that may be included in a network to wake up, and a green mode may refer to an operating mode for saving power used by the router through a power-saving or idle function.

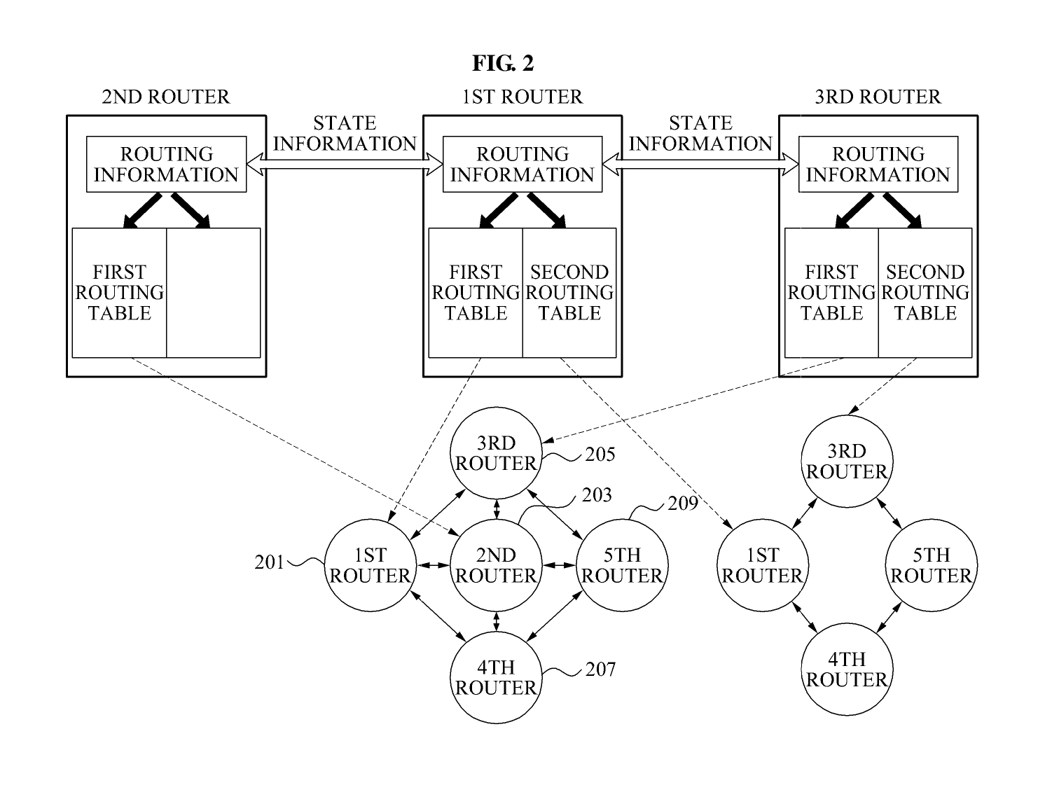

FIG. 2 is a diagram illustrating a configuration of a network including a router using power saving routing information according to an embodiment of the present invention.

Referring to FIG. 2, a network may include a plurality of routers, for example, a first router 201, a second router 203, a third router 205, a fourth router 207, and a fifth router 209.

The routers may exchange state information of the routers. That is, each of the routers may transmit state information to a neighboring router, receive state information of the neighboring router, and generate a plurality of pieces of routing information, for example, a routing table, using the received state information. Here, the state information may include an operating state for each mode in the neighboring router.

For example, the first router 201 may transmit state information of the first router 201 to the second router 203, receive state information of the second router 203 from the second router 203, and generate a plurality of pieces of routing information using the received state information. Here, the first router 201 may receive, as the state information of the second router 203, an operating state for each mode in the second router 203, for example, information regarding a link, a port, or whether the second router 203 is operated in a normal mode or a green mode, and may generate routing information for each mode. Here, the green mode may refer to a mode in which a router may be operated in a power saving state or may not be operated in an idle state. Whether the second router 203 is operated may be determined based on the controlling of a network server (not shown), or may be determined based on a determination made by an operator input to the second router 203.

When an operating state of a first mode in the second router 203 is associated with an operation of the second router 203, the first router 201 may generate a routing table including information on a route passing through the second router 203. Also, when an operating state of a second mode in the second router 203 is associated with a null operation of the second router 203, the first router 201 may generate a routing table including information on a route bypassing the second router 203.

For example, the first router 201 may generate a first routing table including information on a route passing through the second router 203 that is operated, as first routing information about a normal mode. Also, the first router 201 may generate a second routing table including information on a route bypassing the second router 203 that is not operated, as second routing information about a green mode when the second router 203 switches to the green mode so as to be in a power saving state or in an idle state.

Each of the routers may select routing information corresponding to the operating request from the plurality of pieces of routing information, in relation to the operating request from the network server, and may use the selected routing information when transmitting traffic. In this instance, although each of the routers may receive an input of the operating request from the network server, and may also receive an input of the operating request from an operator, the inputs are not limited thereto.

For example, when a request to be operated in a normal mode is received from the network server or the operator, the first router 201 may select the first routing information about the normal mode from the plurality of pieces of routing information, and may use the selected first routing information when transmitting traffic. Here, the first router 201 may transmit the traffic to the second router 203 using the first routing table including information on a route passing through the second router 203, as the first routing information about the normal mode.

Conversely, when a request to be operated in the green mode is received from the network server or the operator, the first router 201 may select the second routing information about the green mode from the plurality of pieces of routing information, and may use the selected second routing information when transmitting traffic. Here, the first router 201 may restrain the traffic transmission to the second router 203 using the second routing table including information on the route bypassing the second router 203, as the second routing information about the green mode.

Although, for ease of description, it has been described that the first router 201 may generate the plurality of pieces of routing information using the received state information from the second router 203, in the network including a router using power saving routing information, it may not be limited to the foregoing, and the first router 201 may generate the plurality of pieces of routing information using state information received from the third router 205, the fourth router 207, and the fifth router 209.

In a manner similar to the first router 201, each of the second router 203, the third router 205, the fourth router 207, and the fifth router 209 may generate a plurality of pieces of routing information based on state information received from a neighboring router, and may use routing information corresponding to an operating request, among the plurality of pieces of routing information, when transmitting traffic.

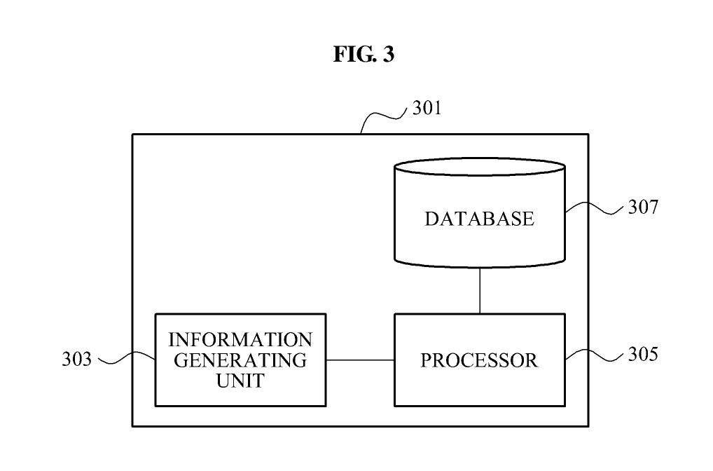

FIG. 3 is a diagram illustrating a configuration of a router apparatus using power saving routing information according to an embodiment of the present invention.

Referring to FIG. 3, a router apparatus 301 using power saving routing information may include an information generating unit 303, a processor 305, and a database 307.

The information generating unit 303 may receive, from a neighboring router, state information about the neighboring router, generate a plurality of pieces of routing information based on the received state information, and store the plurality of pieces of routing information in the database 307.

The information generating unit 303 may receive, as the state information, an operating state for each mode in the neighboring router, for example, information regarding a link, a port, or whether the neighboring router is operated in a normal mode or a green mode, and may generate a plurality of pieces of routing information for each mode.

When an operating state of a first mode is associated with an operation of the neighboring router, the information generating unit 303 may generate a routing table including information on a route passing through the neighboring router. Also, when an operating state of a second mode is associated with a null operation of the neighboring router, the information generating unit 303 may generate a routing table including information on a route bypassing the neighboring router.

For example, the information generating unit 303 may generate a first routing table including information on a route passing through a neighboring router that is operated, as first routing information about the normal mode. The information generating unit 303 may generate a second routing table including information on a route bypassing a neighboring router that is not operated, as second routing information about the green mode.

The processor 305 may select routing information corresponding to the operating request from the plurality of pieces of routing information stored in the database 307, in relation to the operating request from a network server or an operator, and may use the selected routing information when transmitting traffic.

That is, when a request to be operated in the normal mode is received from the network server or the operator, the processor 305 may select the first routing information about the normal mode from the plurality of pieces of routing information, and may use the selected first routing information when transmitting traffic.

Conversely, when a request to be operated in the green mode is received from the network server or the operator, the processor 305 may select the second routing information about the green mode from the plurality of pieces of routing information, and may use the selected second routing information when transmitting traffic.

Here, when the selected routing information corresponds to a routing table including information on a route passing through the neighboring router, the processor 305 may transmit the traffic to the neighboring router. When the selected routing information corresponds to a routing table including information on a route bypassing the neighboring router, the processor 305 may restrain the traffic transmission to the neighboring router.

The database 307 may store the plurality of pieces of routing information.

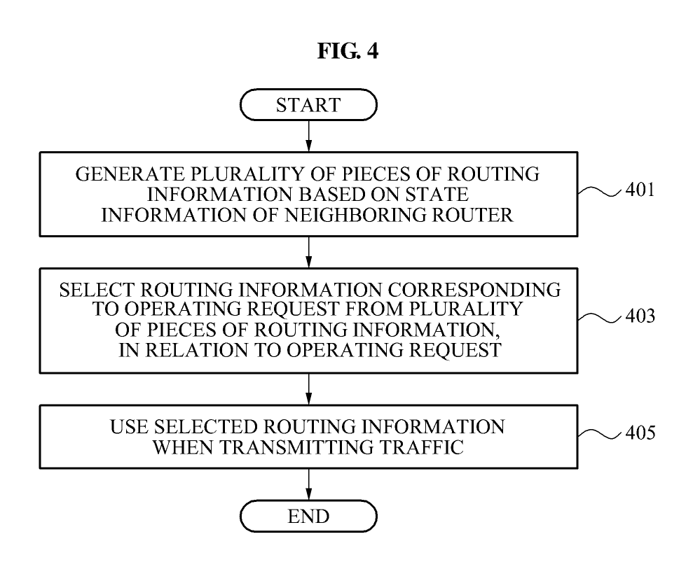

FIG. 4 is a flowchart illustrating a routing method of a router apparatus using power saving routing information according to an embodiment of the present invention.

Referring to FIG. 4, in operation 401, a router apparatus using power saving routing information may receive, from a neighboring router, state information about the neighboring router, and may generate a plurality of pieces of routing information based on the received state information. Here, the router apparatus may receive, as the state information, an operating state for each mode in the neighboring router, for example, information regarding a link, a port, or whether the neighboring router is operated in a normal mode or a green mode, and may generate a plurality of pieces of routing information for each mode.

When an operating state of a first mode is associated with an operation of the neighboring router, the router apparatus may generate a routing table including information on a route passing through the neighboring router. Also, when an operating state of a second mode is associated with a null operation of the neighboring router, the router apparatus may generate a routing table including information on a route bypassing the neighboring router.

For example, the router apparatus may generate a first routing table including information on a route passing through a neighboring router that is operated, as first routing information about the normal mode. The router apparatus may generate a second routing table including information on a route bypassing a neighboring router that is not operated, as second routing information about the green mode.

In operation 403, the router apparatus may select routing information corresponding to the operating request from the plurality of pieces of routing information, in relation to the operating request from a network server or an operator.

When a request to be operated in the normal mode is received from the network server or the operator, the router apparatus may select the first routing information about the normal mode from the plurality of pieces of routing information. When a request to be operated in the green mode is received from the network server or the operator, the router apparatus may select the second routing information about the green mode from the plurality of pieces of routing information.

In operation 405, the router apparatus may use the selected routing information when transmitting traffic.

The router apparatus may transmit the traffic to the neighboring router using a routing table including information on a route passing through the neighboring router, as the selected routing information. The router apparatus may restrain the traffic transmission to the neighboring router using a routing table including information on a route bypassing the neighboring router, as the selected routing information.

For example, when the neighboring router is operated in the normal mode, the router apparatus may transmit the traffic to the neighboring router using the first routing table including information on the route passing through the neighboring router, as the first routing information about the normal mode. Conversely, when the neighboring router is not operated in the green mode, the router apparatus may restrain the traffic transmission to the neighboring router using the second routing table including information on the route bypassing the neighboring router, as the second routing information about the green mode.

According to an aspect of the present invention, by generating a plurality of pieces of routing information about a neighboring router and using routing information corresponding to an operating request, among the plurality of pieces of routing information, traffic may be smoothly transmitted regardless of a state of the neighboring router.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A routing method of a router apparatus using power saving routing information, the method comprising:
receiving, from a neighboring router, state information about the neighboring router, and generating a plurality of pieces of routing information based on the received state information; and
selecting routing information corresponding to an operating request from the plurality of pieces of routing information, in relation to the operating request, and using the selected routing information when transmitting traffic.

2. The method of claim 1, wherein the receiving and generating comprises receiving an operating state for each mode in the neighboring router, as the state information, and generating a plurality of pieces of routing information for each mode.

3. The method of claim 2, wherein the generating of the plurality of pieces of routing information for each comprises generating a routing table including information on a route passing through the neighboring router when an operating state of a first mode is associated with an operation of the neighboring router.

4. The method of claim 2, wherein the generating of the plurality of pieces of routing information for each comprises generating a routing table including information on a route bypassing the neighboring router when an operating state of a second mode is associated with a null operation of the neighboring router.

5. The method of claim 1, wherein the generating of the plurality of pieces of routing information comprises:
generating a routing table including information on a route passing through a neighboring router that is operated, as first routing information about a normal mode; and
generating a routing table including information on a route bypassing a neighboring router that is not operated, as second routing information about a green mode.

6. A router apparatus using power saving routing information, the router apparatus comprising:
an information generating unit to receive, from a neighboring router, state information about the neighboring router, and to generate a plurality of pieces of routing information based on the received state information; and
a processor to select routing information corresponding to an operating request from the plurality of pieces of routing information, in relation to the operating request, and to use the selected routing information when transmitting traffic.

7. The router apparatus of claim 6, wherein the information generating unit receives an operating state for each mode in the neighboring router, as the state information, and generates a plurality of pieces of routing information for each mode.

8. The router apparatus of claim 7, wherein when an operating state of a first mode is associated with an operation of the neighboring router, the information generating unit generates a routing table including information on a route passing through the neighboring router.

9. The router apparatus of claim 7, an operating state of a second mode is associated with a null operation of the neighboring router, the information generating unit generates a routing table including information on a route bypassing the neighboring router.

10. The router apparatus of claim 6, wherein the information generating unit generates a routing table including information on a route passing through a neighboring router that is operated, as first routing information about a normal mode, and generates a routing table including information on a route bypassing a neighboring router that is not operated, as second routing information about a green mode.
